(19) United States
(12) Patent Application Publication
(10) Pub. No.: US 2004/0200734 A1
(43) Pub. Date: Oct. 14, 2004

(54) Nanotube-based sensors for biomolecules

(76) Inventors: Man Sung Co, Cupertino, CA (US); Lian Zhang, Sunnyvale, CA (US); Gang Gu, Palo Alto, CA (US); Lawrence Pan, Los Gatos, CA (US); Jim Protsenko, San Jose, CA (US)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025, US

(21) Appl. No.: 10/742,665

(22) Filed: Dec. 19, 2003

Related U.S. Application Data
(60) Provisional application No. 60/435,382, filed on Dec. 19, 2002.

(51) Int. Cl. G01N 27/26

(52) U.S. Cl. 205/777.5; 204/403.01

(57) ABSTRACT

In one embodiment, the present invention provides for a nanotube-based sensor for detecting a biomolecule comprising one or a plurality of nanotubes, a first electrode and a second electrode connected to said nanotubes, a microfluidic system, and a plurality of immobilized biomolecules, wherein said plurality of immobilized biomolecules are immobilized on said plurality of nanotubes, said plurality of nanotubes are integrated to said microfluidic system, and said first electrode and said second electrode are connected to provide to electrical readout. In another embodiment, said plurality of immobilized biomolecules are immobilized on said substrate or said electrodes or the said microfluidics system. In another embodiment, the sensors are integrated to provide an array of sensors. The present invention further provides for methods to detect a biomolecule using the nanotube-based sensors or arrays of sensors.

### CROSS-REFERENCE TO RELATED APPLICATIONS

The present patent application claims priority from provisional patent application No. 60/435,382, filed on Dec. 19, 2002, which is incorporated herein by reference in its entirety.

### BACKGROUND OF THE INVENTION

1). Field of the Invention

This invention relates generally to carbon nanotube devices, and in particular, to carbon nanotube-based sensors for biomolecules.

2). Discussion of Related Art

The structural, mechanical, and electrical properties of carbon nanotubes make them useful for making microscopic electrical, mechanical, or electromechanical devices. Nanotubes represent a truly nanoscale wire with 1-2 nm diameters. After almost a decade of worldwide research in these materials, their structure and many unique properties have been identified and characterized. These include rich electrical properties, extreme mechanical strength and unique chemical properties. Equally important is that the last several years have witnessed tremendous improvements in nanotube growth and manufacturing techniques. Much progress has been made in controlling the growth of nanotubes and obtaining organized nanotube structures on substrates for further device integration. See U.S. Pat. Nos. 6,346,189, 6,232,706, and 6,401,526, Franklin, et al., Appl. Phys. Lett. 79, 4571 (2001) and Zhang, et al., Appl. Phys. Lett. 79, 3155 (2001), which are incorporated herein for reference for all purposes.

It has recently been shown that carbon nanotubes and semiconducting nanowires can be used for chemical sensors with high sensitivity and rapid response time. See J. Kong, et al., Science 287, 622 (2000), Y. Cui, et al., Science 293, 1289 (2001), M. Shim, et al., Nano Lett, 2. 285-288 (2002) and M. Law, et al., Angew. Chem. Int. Ed. 41, 2405 (2002), which are incorporated herein for reference for all purposes. The detection scheme with the nanotube sensor is based on chemical interactions between the surface atoms of the nanotube and adsorbed molecules. The high surface-to-volume ratio of nanotubes and nanowires make their electrical properties extremely sensitive to surface-adsorbed species. This makes the nanotube sensor an ideal tool for detecting minute quantities of biomolecules for medical and environmental health purposes.

These nanotube devices can be built on a silicon substrate to provide for arrays of nanotube electronic sensors. The small size of each individual sensor thus allows high-density arrays to be constructed on a chip. These high-density array protein chips may be useful for drug screening, study of protein interactions or disease diagnostics.

A vast number of new drug targets are now being identified using a combination of genomics, bioinformatics, genetics, and high-throughput (HTP) biochemistry. The information gained from the combination of these approaches is expected to boost the number of drug targets, usually proteins, to over 10,000 in the coming decade.

The number of chemical compounds available for screening as potential drugs is also growing dramatically due to recent advances in combinatorial chemistry, the production of large numbers of organic compounds through rapid parallel and automated synthesis. The compounds produced in the combinatorial libraries being generated will far outnumber those compounds being prepared by traditional, manual means, natural product extracts, or those in the historical compound files of large pharmaceutical companies.

Both the rapid increase of new drug targets and the availability of vast libraries of chemical compounds create an enormous demand for new technologies which improve the screening process. There is thus a need for miniaturized biomolecule arrays and for methods for the parallel, in vitro, high-throughput screening for potential drug compounds in a manner that minimizes reagent volumes. The present invention is directed to a nanotube-based biosensor array that fulfills these needs.

### SUMMARY OF THE INVENTION

In one embodiment, the present invention provides for a nanotube-based sensor for detecting a biomolecule comprising at least one nanotube, a first electrode and a second electrode connected to said nanotubes, a microfluidic system, and a plurality of immobilized biomolecules, whereas said plurality of immobilized biomolecules are immobilized on said plurality of nanotubes, said plurality of nanotubes are integrated with said microfluidic system, and said first electrode and said second electrode are connected to provide an electrical readout.

In another embodiment, the present invention provides for an array of sensors for detecting biomolecules comprising a plurality of nanotube-based sensors arranged in discrete, known regions on a substrate, whereas different biomolecules or identical biomolecules are immobilized on each sensor of the array. In one preferred embodiment, protein molecules are immobilized on the nanotubes of the sensors.

The present invention further provides for methods for using the sensor to detect a biomolecule that binds to the immobilized biomolecules on the nanotubes. In one embodiment, methods are provided for the array to screen a plurality of proteins in parallel for their ability to bind or otherwise interact with a component of a fluid sample. Most of these methods involve first delivering the fluid sample to the array. If binding is to be detected, the array may then be optionally washed to remove any unbound component from the area. The methods then involve detecting, by a direct electrical readout, the presence or absence of the component retained at each sensor or other evidence of an interaction of the protein of a given sensor with the component. Such methods may be used as a diagnostics tool to screen a fluid sample for the presence, absence, or amount of a plurality of analytes which are associated with certain diseases.

In yet another embodiment, the present invention provides for a sensor for detecting a biomolecule comprising one or a plurality of nanotubes on a substrate, a first electrode and a second electrode connected to said nanotubes, a microfluidic system, and a plurality of immobilized biomolecules, whereas said plurality of immobilized biomolecules are immobilized on said substrate or on said contacts, said plurality of nanotubes and said immobilized biomolecules are enclosed by said microfluidic system, and said first electrode and said second electrode are connected to provide an electrical readout. In still yet another embodiment, the present invention provides for a sensor without immobilized biomolecules.

### BRIEF DESCRIPTION OF THE DRAWINGS

The accompanying drawings, which are incorporated in and form a part of the specification, illustrates embodiments of the invention and, together with the description, serve to explain the principles of the invention:

The invention is described by way of example with reference to the accompanying drawings, wherein:

FIG. 1 is a schematic diagram of a nanotube electronic device in accordance with one embodiment of the invention;

FIG. 2A is a schematic top view of a substrate with unpatterned catalyst;

FIG. 2B is a schematic top view of a substrate with patterned catalyst;

FIG. 3A is a schematic top view of a substrate with nanotubes and patterned metal contacts for the substrate with unpatterned catalyst;

FIG. 3B is a schematic top view of a substrate with nanotubes and patterned metal contacts for the substrate with patterned catalyst;

FIG. 4 shows adsorption of COX-1 to nanotubes and the nanotube response to binding of acetylsalicylic acid to nanotubes immobilized with COX-1;

FIG. 5 shows the nanotube response to interaction of glucose with glucose oxidase immobilized on nanotubes;

FIG. 6 shows the nanotube response to hydrogen peroxide; and

FIG. 7 shows a schematic diagram for an array of sensors.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

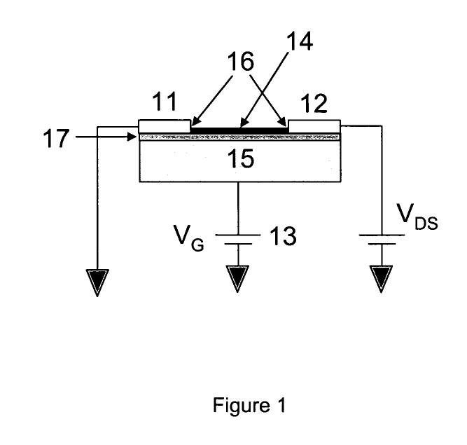

The basic structure for a nanotube sensor is shown in FIG. 1. Each sensor includes a source electrode 11, a drain electrode 12, an optional gate electrode 13, and at least one nanotube or a network of nanotubes 14 connecting the source and the drain to form a field-effect transistor, if the gate electrode 13 is present. The device is fabricated on a substrate 15, which may be any insulating material, for example silica based, or any conducting material, for example silicon, provided that there is an insulating layer 17 between the said conducting substrate and the said electrodes 11 and 12 and nanotubes 14. A junction 16 between the nanotubes 14 and at least one of the electrodes 11, 12 acts as a sensing element. Specificity for particular molecules in a fluid analyte is controlled by the choice of material used for at least one of the electrodes 11, 12. The nanotubes 14 may be single-walled carbon nanotubes (SWNT), having a diameter of between 1 to 2 nm. Further, the nanotubes 14 may comprise a single tube, multiple tubes or a network of interconnected tubes. In some embodiments, the nanotubes 14 may be multi-walled nanotubes (MWNT). The nanotubes 14 may be semiconducting depending on the chirality of the nanotube. At least one of the electrodes 11 and 12 may be of metal or an alloy. For example, the electrodes 11, 12 may be of Ti, Pd, Au. It should be noted that while the present invention is described using carbon based nanotubes this is intended to be non-limiting. Thus, nanotubes made of materials other than carbon, e.g., silicon nanowires and inorganic nanorods, may also be used.

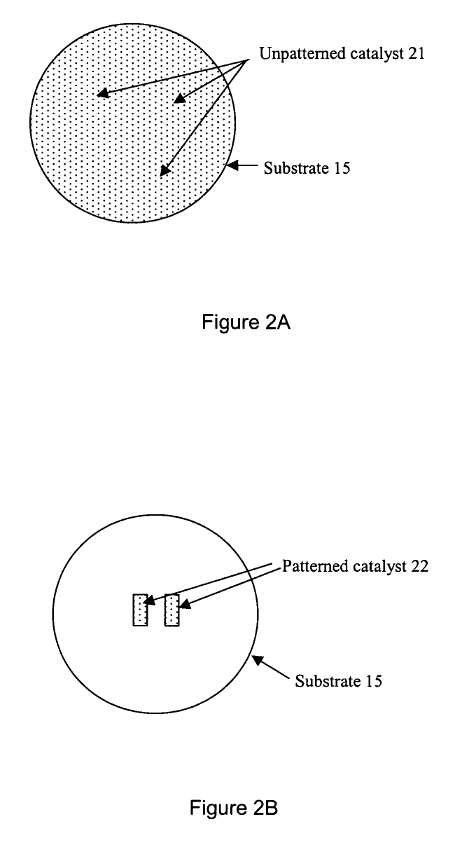

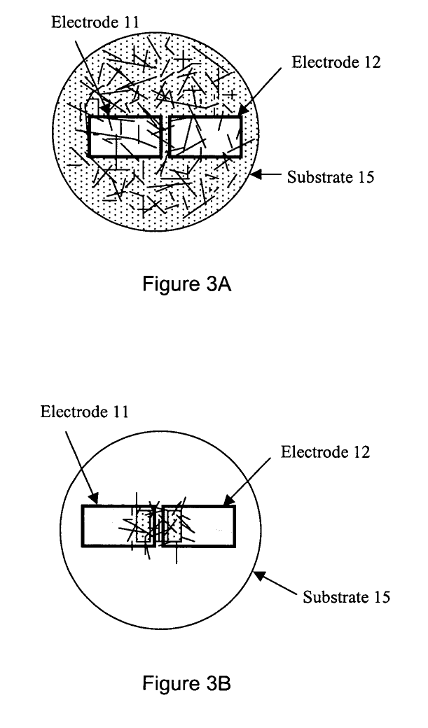

The fabrication of carbon nanotube sensors may be based on nanotubes grown from an unpatterned catalyst 21 over a substrate 15, as illustrated in FIG. 2A. Alternatively the fabrication may be based on a patterned catalyst 22 over a substrate 15 as illustrated in FIG. 2B. Catalyst sites 21 or 22 on a substrate 15 lead to the growth of nanotubes from these sites. Following either unpatterned or patterned catalyst growth, optical lithography is then used for placing metal electrodes 11 and 12 to connect to the nanotubes in a controlled manner, as shown in FIG. 3A for the unpatterned catalyst and in FIG. 3B for the patterned catalyst. One procedure includes the following steps:

(1) Catalytic particles are attached to the entire surface of the substrate 15 for unpatterned growth (FIG. 3A) or patterned on a substrate to form catalyst arrays for patterned growth (FIG. 3B). The patterning is done by a shadow mask or a photolithography technique.

(2) SWNTs are then grown by chemical vapor deposition from the catalyst sites.

(3) Metal electrodes 11 and 12 are then placed onto SWNTs grown from the catalyst patterns by an optical lithography, metallization and liftoff procedure. In the case of patterned growth, this lithography step may involve optical alignment in registry with the catalyst patterns (See FIG. 3B). Growth by CVD combined with the microfabrication approach is a scalable approach to produce nanotube electronic devices including sensors.

Sensor Array

An “array,” as used herein, refers to a plurality of sensors arranged in a two-dimensional pattern with each sensor located in a pre-defined position. An array will comprise two or more sensors. In most cases, the array will comprise at least about ten sensors. In a preferred embodiment, the array comprises at least about 50 sensors. In a particularly preferred embodiment, the array comprises at least about 100 sensors. In alternative preferred embodiments, the array comprises more than 10³, 10⁴ or 10⁵ sensors.

The area of surface of the substrate covered by each of the sensor is preferably no more than about 1 cm². Preferably, the area of the substrate surface covered by each of the sensor is between about 1 mm² and about 0.01 mm². In a particularly preferred embodiment, each sensor covers an area of the substrate surface from about 100 μm² to about 2,500 μm².

In a preferred embodiment of the array, the sensors of the array are all contained within an area of about 3 cm² or less on the surface of the substrate. In one preferred embodiment of the array, the array comprises 10 or more sensors within a total area of about 3 cm² or less on the surface of the substrate.

Alternatively, a particularly preferred array comprises 10³ or more sensors within a total area of about 3 cm² or less. A preferred array may even optionally comprise 10⁴ or 10⁵ or more sensors within an area of about 3 cm² or less on the surface of the substrate.

The sensor array is optionally integrated with a microfluidic system or device to provide for the delivery and flow of minute amounts of fluids to the sensing component, i.e., the nanotubes, of the sensor device.

Microfluidic System

The term “microfluidics” describes a system or device having channels, chambers, reactors, pumps, valves, mixers, switches, inlets, outlets and components which control the flow of fluids in devices and are generally fabricated at sub-millimeter scale. Microfluidic devices based on capillaries that typically have lateral dimensions of 10-100 μm are now applied in medical analysis, environmental monitoring, biochemical analysis, and microchemistry. Simple two-dimensional channel systems can be used for many applications. More complex devices may require pumps, valves, detectors, and channel systems that are three-dimensional. See McDonald et al., Acct. Chem. Res. 35, 491 (2002), which is incorporated herein for reference for all purposes.

The microfluidic systems or devices may be fabricated in silicon, glass and polymers. The first microfluidic devices used silicon and glass, since the techniques for fabrication in these materials were well-developed. See Microsystem Technology: A Powerful Tool for Biomolecular Studies, Kohler, J. M. et Al. Edsl, Birkhauser Verlag, Boston (1999), which is incorporated herein for reference. More recently, fabrication in polymers has become popular because their use as materials reduces the time, complexity, and cost of prototyping and manufacturing. Poly(dimethylsiloxane) (PDMS) is particularly attractive in prototyping new systems because fabrication of systems of channels in PDMS is straightforward and can be cast against a suitable mold with sub-0.1-micron fidelity. See Duffy, D et al., Anal. Chem. 70, 4974 (1998), and McDonald et al., Acct. Chem. Res. 35, 491 (2002), which are incorporated for reference for all purposes. Since the fabrication of systems in PDMS is simple, chemists and biologists can make devices quickly and easily. High-density microfluidic chips that contain plumbing networks with thousands of micromechanical valves and hundreds of individually addressable chambers have also been reported. See Thorsen, T. et al., Science 298, 580 (2002), which is incorporated herein for reference for all purposes.

Many methods are available for the transport and direction of fluids, e.g., samples, analytes, buffers and reagents within these microfluidic systems or devices. A straightforward method applies external pressure to move fluids within the device. See Wilding et al., U.S. Pat. No. 5,304,487, which is incorporated herein for reference. One method moves fluids within microfabricated devices by mechanical micropumps and valves within the device. See U.S. Pat. Nos. 5,271,724 and 5,277,556, which are incorporated herein for reference. Another method uses acoustic energy to move fluid samples within devices by the effects of acoustic streaming. See Published PCT Application No. 94/05414 for reference. Still another method uses electric fields to move fluid materials through the channels of the microfluidic systems. See Harrison et al., Anal. Chem., 64, 1926 (1992) and U.S. Pat. No. 5,126,022, which are incorporated herein for reference.

The integration of a microfluidic system into the nanotube sensor is beneficial because the use of volumes smaller than 1 μl generates significant problems with evaporation, dispensing times, protein inactivation, and assay adaptation. Proteins are very sensitive to the physical and chemical properties of the reaction chamber surfaces. Proteins are prone to denaturation at the liquid/solid and liquid/air interfaces. Miniaturization of assays to volumes smaller than 1 μl increases the surface to volume ratio substantially. Furthermore, solutions of submicroliter volumes evaporate rapidly, within seconds to a few minutes, when in contact with air. Maintaining microscopic volumes in open systems may be problematic.

Biomolecules

The term “biomolecules” generally refers to molecules of the type found within living organisms or cells, and chemical compounds interacting with such molecules. Biomolecules include nucleic acids, proteins, peptides, polysaccharides, lipids, hormones and natural or synthetic compounds that interact with such molecules. For example, nucleic acids include deoxyribonucleic acids, oxyribonucleic acids, nucleotides, nucleosides, oligonucleotides, polynucleotides and other synthetic counterparts. Proteins generally refer to polymers of amino acid residues and include peptides and polypeptides of natural and synthetic amino acid residues. The small molecules that interact with biomolecules may be isolated, for example, from natural product extracts or synthesized, for example, by combinatorial methods.

The proteins may be members of a protein family such as a receptor family (examples: growth factor receptors, catecholamine receptors, amino acid derivative receptors, cytokine receptors, lectins), ligand family (examples: cytokines), enzyme family (examples: proteases, kinases, phosphatases, ras-like GTPases, hydrolases), and transcription factors (examples: steroid hormone receptors, heat-shock transcription factors, zinc-finger proteins, leucine-zipper proteins). In a preferred embodiment, the protein immobilized on each sensor is an antibody or antibody fragment. The antibodies or antibody fragments of the array may optionally be single-chain Fvs, Fab fragments, Fab′ fragments, F(ab′)₂ fragments, Fv fragments, dsFvs diabodies, Fd fragments, full-length, antigen-specific polyclonal antibodies, or full-length monoclonal antibodies. In a preferred embodiment, the immobilized proteins on the sensors of the array are monoclonal antibodies, Fab fragments or single-chain Fvs.

In another preferred embodiment of the invention, the biomolecules are immobilized on the nanotubes of the sensors using an immobilization agent such as 1-pyrenebutanoic acid, succinimidyl ester. With 1-pyrenebutanoic acid, succinimidyl ester, the pyrenyl group, being highly aromatic in nature, interacts strongly with the sidewalls of nanotubes via pi-stacking. The succinimidyl ester group is used to covalently conjugate the desired biomolecules, e.g., proteins, antibodies or ligands containing amine groups through the formation of amide bonds. See Chen, R., et al., J. Am. Chem. Soc. 123, 3838 (2001), which is incorporated herein for reference for all purposes.

Biological interactions include the full range of catabolic and anabolic reactions which occur in living systems including enzymatic, binding, signaling and other reactions. Biochemical systems of particular interest include, e.g., receptor-ligand interactions, enzyme-substrate interactions, cellular signaling pathways, transport reactions involving model barrier systems (e.g., cells or membrane fractions) for bioavailability screening, and a variety of other general systems.

Applications

In one embodiment of the present invention, a nanotube-based sensor is provided for detecting a biomolecule comprising one or a plurality of nanotubes, a first electrode and a second electrode connected to said nanotubes, a microfluidic system, and a plurality of immobilized biomolecules, whereas said plurality of immobilized biomolecules are immobilized on said plurality of nanotubes, said plurality of nanotubes are integrated with said microfluidic system, and said first electrode and said second electrode are connected to provide to electrical readout.

In another embodiment, the present invention provides for an array of sensors comprising a plurality of nanotube-based sensors arranged in discrete, known regions on a substrate, whereas different biomolecules are immobilized on each sensor of the array. Alternatively, an identical biomolecule may be immobilized on each sensor of the array, for example, for screening drug candidates against a specific biomolecule.

In one aspect of the invention, protein molecules are immobilized on the nanotubes of the sensors. The protein immobilized on one sensor of the array is preferably different from the protein immobilized on a second sensor. In an especially preferred embodiment, the protein that is immobilized on one sensor of the array is a member of the same protein family as or is otherwise functionally or structurally related to the proteins immobilized on the other sensor of the array. The array is then employed to identify a component of a fluid sample through bindings or interactions with a protein or a plurality of proteins from a fluid sample such as cellular lysate or bodily fluid. Most of these methods involve first delivering the fluid sample to the array. If binding is to be detected, the array may then be optionally washed to remove any unbound component from the area. The methods then involve detecting, by a direct electrical readout, the presence or absence of the component retained at each sensor or other evidence of an interaction of the protein of a given sensor with the component.

In another aspect, the present invention provides for methods for screening drug candidates against a therapeutic target. The target biomolecule is immobilized on the nanotubes of each sensor of the array. Drug candidates, which may be natural compounds or synthetic compounds, are delivered separately to each sensor of the array via a microfluidic system. The array may then be optionally washed to remove any unbound compounds from the area. Compounds bound to the immobilized biomolecules will give rise to an electrical readout, through the electrodes connected to the nanotubes.

In yet another aspect of the present invention, a nanotube-based sensor detects a product or by-product of an enzymatic reaction, such as hydrogen peroxide produced by enzyme glucose oxidase, as shown in Example 4 below. Taking advantage of the detectability of a reaction product, applications may be developed with the nanotube-based sensors or sensor arrays. For example, a sensitive glucose test may be developed for a glucose-containing fluid sample by constructing a sensor device immobilized with glucose oxidase, which may be immobilized on the nanotubes or on the substrate or on the contacts. Hydrogen peroxide produced will be detected by the nanotubes to provide an electrical readout.

In still yet another aspect of the invention, glucose oxidase may be conjugated to an antibody to develop an ELISA-type assay using the electrical readout provided by the interaction of nanotubes with hydrogen peroxide. For example, a first antibody recognizing an analyte molecule is immobilized on the nanotubes or on the substrate or on the contacts by incubating the antibody in an appropriate buffer with the nanotubes. Then, a sample analyte is delivered to the incubation chamber. After an incubation period, the sample is removed and the chamber is rinsed with buffer. A second antibody recognizing a different epitope on the analyte molecule and conjugated to the glucose oxidase is then delivered to the chamber and allowed to bind to the analyte. After another incubation period, the unbound second antibody is removed and the chamber rinsed again. Glucose is finally delivered to the chamber; hydrogen peroxide is produced and the conductance is read at a determined time. The sample analyte and a series of standards may be processed simultaneously on the array of sensors. The concentration of the analyte is determined. The above procedure may be performed manually or with an automated sample delivery system.

These sensors and sensor arrays are generally integrated with a microfluidic system to allow buffers, reagents and analytes to be delivered to the sensing component, i.e., the nanotubes, of the sensor device. When an immobilized biomolecule encounters a biological interaction, charge transfer or small changes in the charge-environment of the semiconducting nanotubes can cause drastic changes to the electrical properties of the nanotubes, giving rise to an electrical signal detection and readout.

Such biological interaction can be a binding of a small molecule drug to a protein target, in which case the sensors may be utilized for drug screening. A high-density of array of sensors integrated with a microfluidic system and sample loading system may provide a means for high throughout screening. A sensor or an array of sensors immobilized with biomolecules associated with certain diseases may be developed into disease diagnostic devices. A sensor or an array of sensors capable of detecting protein-protein interactions may be employed to study protein kinetics and to measure binding affinities. A sensor or an array of sensors capable of detecting products or intermediates of an enzymatic reaction may allow such an enzyme to be detected to provide a sensitive biological assay.

The examples below are provided by way of illustration only and should not be construed to limit the invention.

### EXAMPLE 1

Construction of a Nanotube Electronic Sensor

A nanotube electronic sensor was fabricated on the patterned growth of SWNTs on full 4-inch SiO₂/Si wafers. A SiO₂/Si wafer was first fabricated to get the alignment marks by standard photolithography with 1 μm Shipley 3612 as photoresist. Then the patterned catalyst islands were fabricated with a quartz mask and dry etching on PMMA and Shipley 3612 coated silicon wafer. Afterwards a thin catalyst layer of suspension consisting of 15 ml methanol, 0.05 mmol Fe(NO₃)₃ 9H₂O, 0.015 mmol MoO₂(acac)₂, and 15 mg Degussa alumina nanoparticles was coated on the patterned substrate. After lifting off with acetone, single-walled carbon nanotubes were grown at 900° C. for 7 min with 1.08 SLM CH₄ and 125 SCCM H₂. After tube growth, standard photolithography was applied again for metal electrodes with alignment marks. Ti, Pd and Au have been used as source and drain electrodes, with a highly doped Si wafer used as a backgate. The thickness of the thermal oxide layer of SiO₂ is about 100-500 nm. Cleaning procedures were applied by heating the devices in acetone at 50° C. for 1 hour and then on a hot plate at 300° C. for 1 hour to provide a clean surface after lift-off.

### EXAMPLE 2

Drug Screening on a Nanotube Electronic Sensor

To demonstrate the protein-small molecule interaction on a nanotube sensor, the enzyme cyclooxygenase 1 (COX-1) was selected to study its interaction with acetylsalicylic acid (aspirin). COX is a key enzyme in the production of inflammatory agents and is the target of intense research and drug discovery activities.

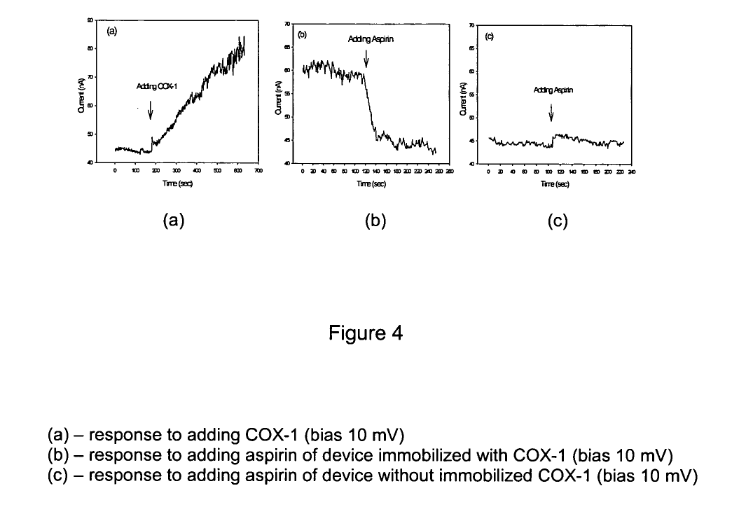

COX-1, a 70 kDa homodimer isolated from ram seminal vesicles, was obtained from Sigma. The protein was immobilized by incubating 1 μl of the protein solution (2.5 μM in 80 mM Tris, pH 8.0 and 0.1% Tween 20) onto the nanotubes. Conductance on the nanotubes increased gradually as the protein was immobilized (FIG. 4(a)). Control incubation with the buffer alone indicated that part of the observed effect was due to adsorption of Tween 20 on the nanotubes. The nanotubes were rinsed with water twice before incubating with 1 μl of 1 mM acetylsalicylic acid. Upon addition of the drug, a rapid decrease of conductance was observed (FIG. 4(b)). In contrast, addition of the drug to nanotubes not immobilized with COX-1 showed no appreciable conductance change (FIG. 4(c)). This indicates that a nanotube-based biosensor is capable of detecting drug interactions with a protein target.

### EXAMPLE 3

Detection of an Enzymatic Reaction on a Nanotube Electronic Sensor

To demonstrate the capability of a nanotube sensor to detect an enzymatic reaction, glucose oxidase (GOx), an enzyme catalyzing the oxidation of β-D-glucose to gluconolactone and generating hydrogen peroxide (H₂O₂), was selected. This enzyme has been used for assaying glucose in biological fluids and may be conjugated to an antigen or antibody for use in ELISA procedures as described above.

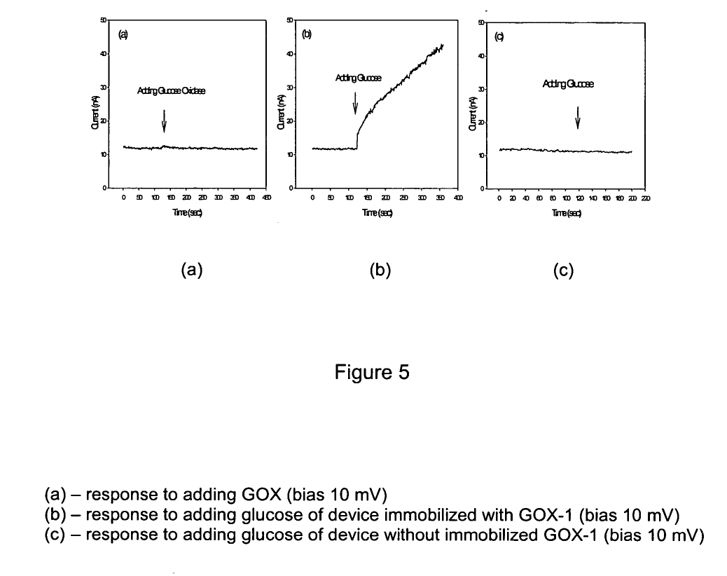

GOx, a flavoenzyme with a molecular weight of 160 kDa and 2 molecules of FAD which are essential for its activity, was obtained from Sigma. The protein was immobilized by incubating 1 μl of the protein solution (25 μM in 0.1 M acetate buffer, pH 4) on the nanotubes. The immobilization of GOx does not impact appreciable change in conductance to the nanotubes (FIG. 5(a)). Whether immobilization of proteins on the nanotubes affects the conductance change in nanotubes is likely a property of the proteins. The nanotubes were rinsed with water twice before incubating with 1 μl of 1 mM glucose. Upon addition of glucose, a rapid increase in conductance was observed (FIG. 5(b)). As a control, addition of glucose to nanotubes not immobilized with GOx shows no appreciable conductance change (FIG. 5(c)). This indicates that a nanotube-based biosensor is capable of detecting an enzymatic reaction.

### EXAMPLE 4

Enzyme Linked Assays

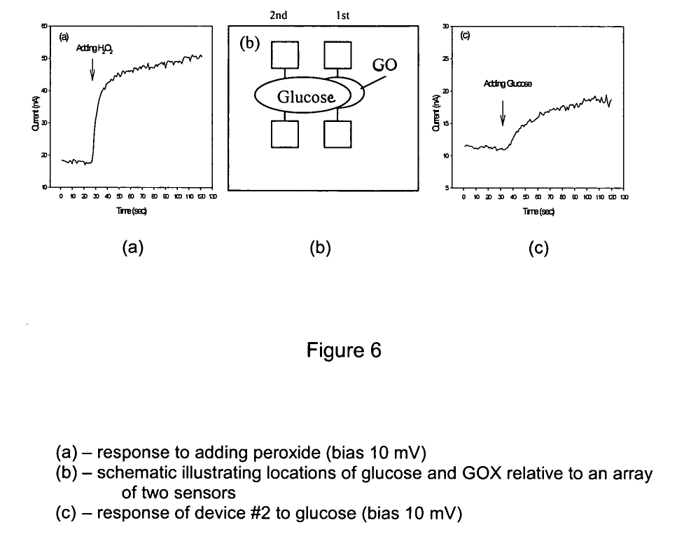

Hydrogen peroxide, a product of the glucose oxidase reaction, is a strong oxidizer and may account for the conductance change on the nanotubes shown in Example 3 above. FIG. 6(a) shows a rapid conductance response to plain nanotubes upon addition of 1% H₂O₂. An experiment was designed to determine if the conductance change in Example 3 above was due to the H₂O₂ production. Two adjacent nanotube sensors were employed as shown in FIG. 6(b). The nanotubes on the first sensor were immobilized with glucose oxidase. A glucose solution was added to cover nanotubes on both first and second sensors. Electrical readout was obtained from the second sensor (FIG. 6(c)). This shows that H₂O₂ generated from the first sensor diffuses to the second sensor to produce the electrical readout on the second sensor.

An enzyme linked assay on a nanotube-based device is described as follows. A first antibody Ab1 recognizing an analyte molecule is immobilized on the nanotubes by incubating the antibody in an appropriate buffer with the nanotubes. The time of incubation may be from 30 min. to overnight. An appropriate buffer is a 10 mM sodium phosphate buffer, pH 7.4, or phosphate buffered saline (PBS). After incubation, Ab1 is removed and the incubation chamber is rinsed with buffer. A sample analyte is delivered to the incubation chamber and incubated for a period of time. The sample is removed and the chamber is rinsed with buffer. A second antibody Ab2 recognizing a different epitope on the analyte molecule and conjugated to the glucose oxidase is delivered to the chamber and allowed to incubate. After incubation for a period of time, the reagent is removed and the chamber rinsed again. Glucose is finally delivered to the chamber and the conductance from the device is read at a determined time.

### EXAMPLE 5

Design of Sensor Array

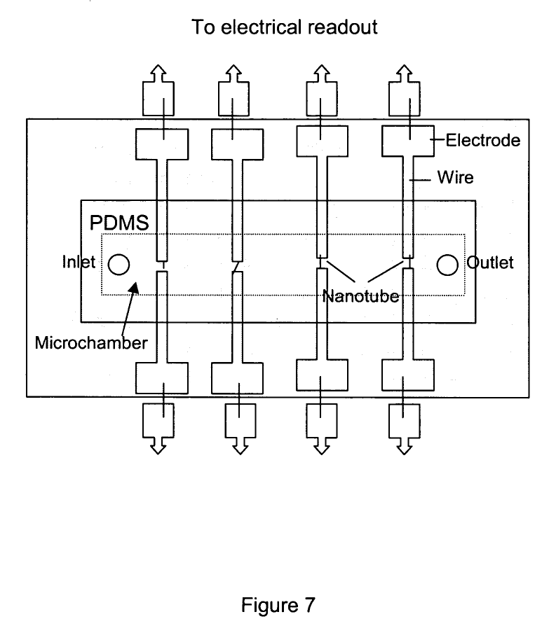

A sensor array is designed for detection of biomolecules. A schematic diagram of the array is shown in FIG. 7. The diagram shows a four-sensor array on a chip but an array of various numbers of sensors can be constructed. The chip is integrated to a microfluidic system providing a microchamber over the four sensors with an inlet and an outlet for the introduction and outflow of the reagents. The basic structure of a sensor is shown in Example 1 and FIG. 1, except that the backgate is an optional component of the sensor. In one embodiment, the microfluidic component is made of PDMS. In the illustrated example, a microchannel is designed to cover the four sensors and a reagent can be delivered to all four sensors simultaneously. In another embodiment, a PDMS stamp is designed with a separate microchamber over each sensor, each with its own inlet and outlet.

In one embodiment of the invention, a larger incubation chamber is designed to provide a rectangular chamber with an inlet and an outlet and a dimension of 100 μm height, 2 mm width and 5 mm length over a nanotube sensor. This chamber accepts a volume of 1 μl of reagents. Using the standard semiconductor process, a microchannel or microchamber with micron dimensions may be manufactured. For example, the height, the width or the length of the chamber may be from 10 to 500 μm. The shape of the microchamber or the microchannel is flexible, and may be circular, oval, square, rectangular or any geometric shapes. Holes are bored on the PDMS stamp to provide inlet and outlet for the delivery of reagents. A reservoir may be incorporated at the inlets and outlets.

The electrodes are electrically connected to provide a convenient electrical readout. For example, the electrodes are wire-bonded to the electrical pads to provide the connection.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A sensor for detecting a biomolecule comprising:
one or a plurality of nanotubes;
a first electrode and a second electrode connected to said nanotubes;
a microfluidic system; and
a plurality of immobilized biomolecules, wherein said plurality of immobilized biomolecules are immobilized on said plurality of nanotubes, said plurality of nanotubes are integrated to said microfluidic system, and said first electrode and said second electrode are connected to provide an electrical readout.

2. A sensor of claim 1, wherein said nanotubes are carbon nanotubes.

3. A sensor of claim 1, wherein said microfluidic system comprises poly(dimenthylsiloxane).

4. A sensor of claim 1, wherein said immobilized biomolecules comprise proteins.

5. A sensor of claim 1, wherein said immobilized biomolecules comprise nucleic acids.

6. A sensor of claim 1, wherein said immobilized biomolecules comprise antibodies.

7. A sensor of claim 1, wherein said biomolecule to be detected comprises a protein.

8. A sensor of claim 1, wherein said biomolecule to be detected comprises a nucleic acid.

9. A sensor of claim 1, wherein said biomolecule to be detected comprises a natural compound.

10. A sensor of claim 1, wherein said biomolecule to be detected comprises a synthetic compound.

11. An array of sensors for detecting biomolecules, comprising:
a plurality of sensors of claim 1 arranged in discrete, known regions on a substrate, wherein a known first biomolecule is immobilized on the nanotubes of a first sensor; and
a known second biomolecule is immobilized on the nanotubes of a second sensor.

12. An array of sensors of claim 11, wherein a known biomolecule is immobilized on said plurality of sensors.

13. A method for using a sensor to identify an analyte, comprising:
providing a sensor of claim 1;
providing an analyte;
delivering said analyte to said sensor; and
recording an electrical readout.

14. A sensor for detecting a biomolecule, comprising:
one or a plurality of nanotubes on a substrate;
a first electrode and a second electrode connected to said nanotubes;
a microfluidic system; and
a plurality of immobilized biomolecules, wherein said plurality of immobilized biomolecules are immobilized on said substrate, or said electrodes, or said microfluidics system, said plurality of nanotubes and said immobilized biomolecules are enclosed by said microfluidic system, and said first electrode and said second electrode are connected to provide an electrical readout.

15. A method for using a sensor to detect an analyte, comprising:
providing a sensor of claim 14;
providing an analyte;
delivering said analyte to said sensor;
delivering a reagent capable of interacting with said analyte and producing a molecule detectable by said nanotubes of said sensor; and
recording said electrical readout generated by said nanotubes.

16. A sensor for detecting a biomolecule, comprising:
one or a plurality of nanotubes;
a first electrode and a second electrode connected to said nanotubes; and
a microfluidic system, wherein said plurality of nanotubes are integrated to said microfluidic system, and said first electrode and said second electrode are connected to provide an electrical readout.

17. A sensor of claim 16, wherein said nanotubes are carbon nanotubes.

18. A sensor of claim 16, wherein said microfluidic system comprises poly(dimenthylsiloxane).
